(19) United States
(12) Patent Application Publication
(10) Pub. No.: US 2002/0157362 A1
(43) Pub. Date: Oct. 31, 2002

(54) Full contact ganged grass mower housings

(76) Inventor: John F. Nunes JR., Patterson, CA (US)

Correspondence Address: John F. Nunes Jr., 1707 Magnolia Avenue, Patterson, CA, 95363, US

(21) Appl. No.: 09/808,969

(22) Filed: Mar. 16, 2001

(51) Int. Cl. A01D 75/30

(52) U.S. Cl. 56/6; 56/14.9

(57) ABSTRACT

An improved and more efficient rotary mower comprised of a grass cutting assembly having two or more housings, each of said housing supporting and powering a single horizontally rotating blade, each of said housings being mounted as part of a group permitting verticaal motion by a housing and free orientation of its cutting blade independent of the other housings. An extra degree of freedom of motion of the individual housings results from support means which allows vertical motion and pivoting of a housing from a centralized support point. The assembly permits an improved grass cutting means over uneven terrain.

### STATEMENT REGARDING MICROFICHE RECORDS

No microfiche records are used in the application submitted for the present invention.

### FIELD OF INVENTION

This invention relates generally to the field of lawn mowing devices and more particularly to an improved and more efficient means or cutting grass over uneven terrain with multiple cutting units. This result is realized through the use of multiple housings each of which powers a separate horizontal rotating blade beneath the housing, by nesting of the housings in a tight group, by supporting each housing with 3 spaced and castered wheels and by having an additional degree of freedom of motion for each housing not found on existing mowers. The extra degree of freedom allows each housing to move vertically with full pivoting action by a housing relative to the other housings.

### CROSS REFERENCES

None except as set out below in the Prior Art section.

### STATEMENT REGARDING THE USE OF FEDERAL FUNDS

No federal funding, direct or indirect, has been utilized in conjunction with the development of the present invention.

### PRIOR ART

No prior art can be found which discloses the present invention. No prior art can be found which seeks to correct the relative position of a grass cutting housing, relative to other housings, by accommodating both the vertical spacing from the support frame and by allowing axial correction of the cutting plane of the housings in the manner disclosed herein. No prior art stresses the importance of this arrangement which allows full contact for each housing while traveling over uneven terrain.

The current practice involves a variety of means of suppension of the cutting units, none of which allow for independent motion by individual cutting units relative to each other while allowing the group to be lifted together to clear obstacles. Typically existing units have a single housing with more than one cutting blade. Typically for side cutting assemblies, the median plane of the cutting unit is fixed at a given height relative to the transporting unit or is attached to limit downward motion of the assembly. All of these assemblies have the basic defect that the individual cutting units are constrained in their motion by the positions of the other housings and/or by the position of the transporting unit, normally a tractor.

Given the variety of grass cutting devices however, it is important to discuss in detail the various existing grass cutting devices now in use and their limitations with respect to the present invention. There are examples of housings which are connected directly with articulating means. These units, the LASTEC models 421D and425D, do have separate housings but they do not function independent either in a vertical orientation or in a front-to-back orientation relative to each other. The housings for these units are articulated directly to each other by hinging means. The LASTEC model 721XR uses two rows of housings which are attached to the rear of the transport unit with complex articulation, but the housings are raised independently of each other.

The LASTEC models 321, 521 and 721 have a linear array of housings attached to the rear of the transport unit by a diagonal cross bar which reduces the cutting area when turning to the right. The articulation of the housings relative to each other is not independent.

The HOWARD PRICE model 1280 has two housings at the front and two on each side. Each housing has two cutting blades.

The LAND PRIDE models AFM4016, AFM4014, AFM4016, AFM40133 and AFM40200 have single housings on the front and on each side with each housing having two horizontal cutting blades.

The JOHN DEERE models F925 and G735 both have a single housing in front supporting two horizontal cutting blades.

The PROGRESSIVE model PRO-FLEX 120 has 5 housings attached to the rear of the transport nit. each with 4 points of support above the ground and with attachment to a common horizontal cross bar at a fixed hieght above the ground and no common method for elevation of the assembly off the ground.

The JACOBSEN model HR-5111 has a single housing in front with two horizontal cutting blades. The JACOBSEN HR-9016 has a single housing in front with 5 cutting blades and single housings on each side with two cutting blades each. The JACOBSEN TURFCAT has a single housing in front with 3 cutting blades.

The TORO GROUNDMASTER models 1000-L and 120 and Z-MASTER each have single housings in front with 3 cutting blades. The TORO 5XI, 260 and 300 series all have a single housing under the transport unit with 3 cutting blades per housing. One system is known in wich individual cutters operate independently of each other however these are all contained in a singel housing.

In summary none of the existing models optimize the utilization of multiple cutting units as found in the present invention.

### SUMMARY OF THE INVENTION

The present invention is an improved grass mowing apparatus and more particularly one which allows for closer and more uniform cutting of grass over uneven terrain.

The preferred embodiment of the present invention is a cutting assembly comprised of two or more circular housings each of which covers a single horizontally rotating cutting blade. Each housing is supported off of the ground by three castered wheels attached at equal intervals around the periphery of the housing. Said horizontally rotating blade is powered by a vertical shaft connected to and powered by a hydraulic motor attached to the top center of the housing.

Said cutting assembly is attached by attachment means to a powered transport unit, said cutting assembly and said attachment means comprise the present invention and are (1) the pattern of nesting the housings near each other, (2) the housing yoke attachment, said housing yoke attachment affixes a rigid member, a housing yoke, at its upper end to a common lift region and at its lower end by hinged yoke means to the top of a housing, and (3) a bumper structure on a housing which contacts and stabilizes another housing when they are lifted. Said housing yokes are attached at their upper ends to said common lift region by both hinged and axial rotation means.

No existing devices use this combination of a hinged and rotational attachment which has the advantage of allowing individual housings to move over the ground indeplendently of the position of the cross bar and independently of other housings attached to the cross bar and to be raised as a group. This design adds an additional degree of freedom of motion to each housing.

The tight nesting of the housings allows the cutting assembly to be compact and to permit the transporting unit normally a tractor to turn in a smaller radius. Damage to mower having multiple cutting units commonly occurs when the cutting units are lifted. The bumpers on the housings avoid much of the cause of such damage by locking up the housings when they are lifted to avoid jostling the housings against each other. Although there many ways to avoid such jostling, the preferred embodiment of the present invention is the use or a bumper on one housing to contact an adjacent housing when they are lifted. This approach is required due to the extra degree of freedom of motion of the housings and to the compact nesting of the housings.

Groups of housings may be attached to the front, rear and/or on either side of said transport unit. The housings are attached at said common lift region at intervals along a horizontal cross bar. Said cross bar is rotably attached to said transport unit, said rotable attachment being hinged and powered to elevate the cross bar and said housings relative to said transport unit. Housings attached under the transport unit are attached to a cross bar passing under the transport unit. Said cross bar passing under the transport unit can also serve as attachment points for housings on the side of the transport unit.

These and other objects an advantages of the present invention will become clear to those skilled in the art in view of the description of the best presently known mode of carrying out the intention and the applicability of the preferred embodiment as described here in and as illustrated in the several figures of the drawings.

### DESCRIPTION OF THE DRAWINGS

FIGS. 1A and 1B show top schematic views of a tractor.

FIG. 2A is a bottom schematic view of a tractor.

FIG. 2B is a top schematic view of a tractor.

FIG. 3A shows a top view of a mower assembly.

FIG. 3B shows a side view of a mower assembly.

FIG. 4A shows top view of a tilted mower assembly.

FIG. 4B shows a side view of a tilted mower assembly.

FIG. 5 shows a top view of a mower assembly.

FIG. 6 shows a side view of a mower assembly.

FIG. 7 shows a front perspective view of a housing yoke.

FIG. 8 shows a schematic side view of a swing arm and housings.

FIG. 9 shows a schematic side view of a lift joint.

FIG. 10 shows a schematic side view of a motor assembly.

### FULL CONTACT GANGED GRASS MOWER HOUSINGS—SPECIFICATION

Best Mode for Carrying Out Invention

The best mode for carrying out the present invention is the assembly comprised of full contact ganged mower housings as set out herein. The purpose of the assembly is to allow full contact of the mower housings over uneven terrain, each housing containing a single horizontally rotating cutting blade and each of said housings moving vertically and pivoting freely relative to other housings in the assembly. To understand the range of applications and the details of implementing the present invention, reference is made to the drawings. Referring particularly to the figures wherein like-referenced numbers have been applied to like-parts throughout the description:

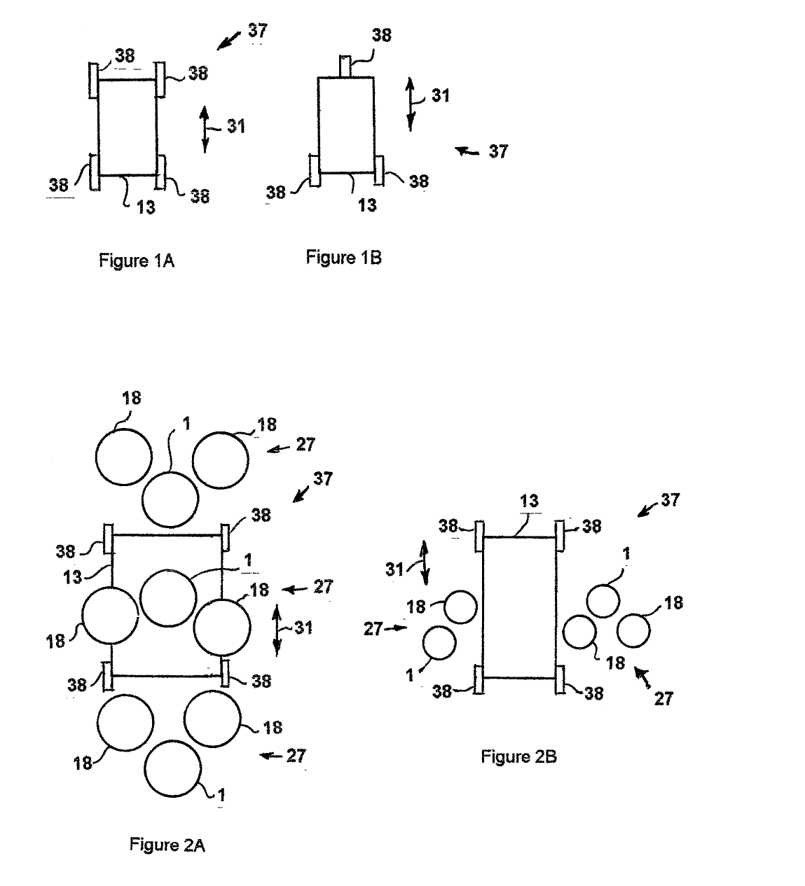

FIGS. 1A and 1B each show a top schematic view of a tractor, which is designated by the general reference number 37. FIG. 1A shows a four wheel tractor comprised of a schematic tractor frame 13 and four wheels 38 rotably affixed to said tractor frame 13. FIG. 1B shows a three wheeled tractor 37 comprised of a schematic tractor frame 13 and three wheels 38 rotably affixed to said tractor frame 13. For both figures the forward and reverse directions of motion of the tractor 37 are indicated by a motion arrow 31. it is understood that the means for turning the tractor 13, not shown utilize a pair of wheels 38 or a single wheel 38 at one end of a tractor. It is also understood that all of said wheels 38 can be utilized in turning the tractor 13.

FIGS. 2A and 2B illustrate schematic views of a tractor 37 with the relative positioning of housings 118 shown when deployed for normal operation. FIG. 2A is a bottom plan view and FIG. 2B is a top plan view. For both figures the forward and reverse directions of motion of the tractor 37 are indicated by a motion arrow 31.

Referring particularly to FIG. 2A three different assemblies of three housings 1, 18 are illustrated relative to a tractor 37 with wheels 38 rotably affixed to the tractor frame 13, said different assemblies being individually designated by the general reference number 27. Said assemblies are each sufficient individually to effectively mow grass. Said assemblies 27 are illustrated attached under said tractor 37 and/or attached at either end of said tractor 37. For all assemblies 27 it is understood that the offsets of the housings 1, 18 from each other is such as to insure that for a tight turning radius of the tractor 37, sufficient overlap in the cutting paths exists by reason of the relatively close placement of the housings 18 for each other.

Referring particularly to FIG. 2B, two separate assemblies 27 of housings 1, 18 are shown to either side of a tractor 37 one assembly 27 having three housings 1, 18 and one assembly 27 having two housings 1, 18. Wheels 38 are rotably affixed to the tractor frame 13.

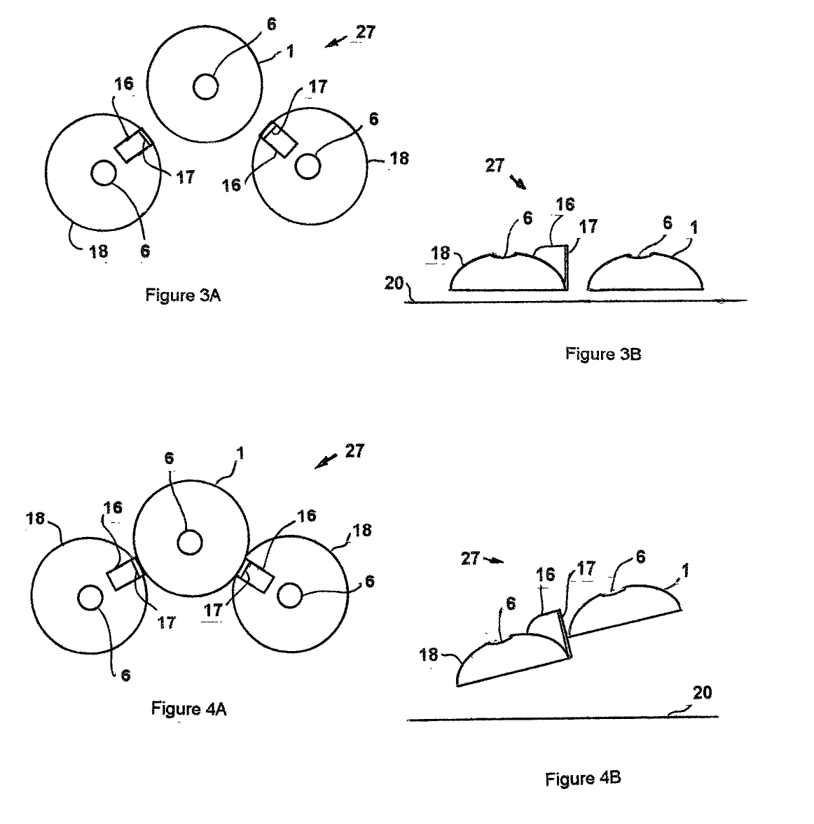

FIG. 3A shows a top schematic view of a mower assembly 27 with a front housing 1 and two side housings 18. FIG. 6 shows a side schematic view of the same mower assembly 27 with more detail. FIG. 3B shows a schematic side view of an assembly 27 as illustrated in FIG. 3A comprised of two housings 1, 18 level with the ground 20. The gap between the front housing 1 and the side housings during normal operation 18 is about two inches and the diameter of the bottom of said housings 1, 18, in the preferred embodiment of the present invention, is about 24 inches and the housing wheels 11 are 9 inches in diameter.

FIG. 4A shows a top schematic view of a tilted mower assembly 27 with a front housing 1 and two side housings 18. FIG. 4B shows a schematic side view of the same tilted assembly 27 comprised of two housings 1, 18 tilted relative to the ground 20. The housings 1, 18 are shown in contact with the lower rearward edge of the front housing 1 touching a barrier comprised of a top bumper 16 faced with a bumper guard 17, said bumper guard 17 made of a resilent plastic material, said a top bumper 16 being affixed to a housing 18 as shown in FIGS. 3A, 3B, 4A and 4B. The bottoms of said housings 1, 18 are roughly parallel and are tilted with respect to the ground 20. Due to said contact, minimal movement between the front housing 1 and each side housing 18 occurs when the mowing assembly 27 is in the tilted position.

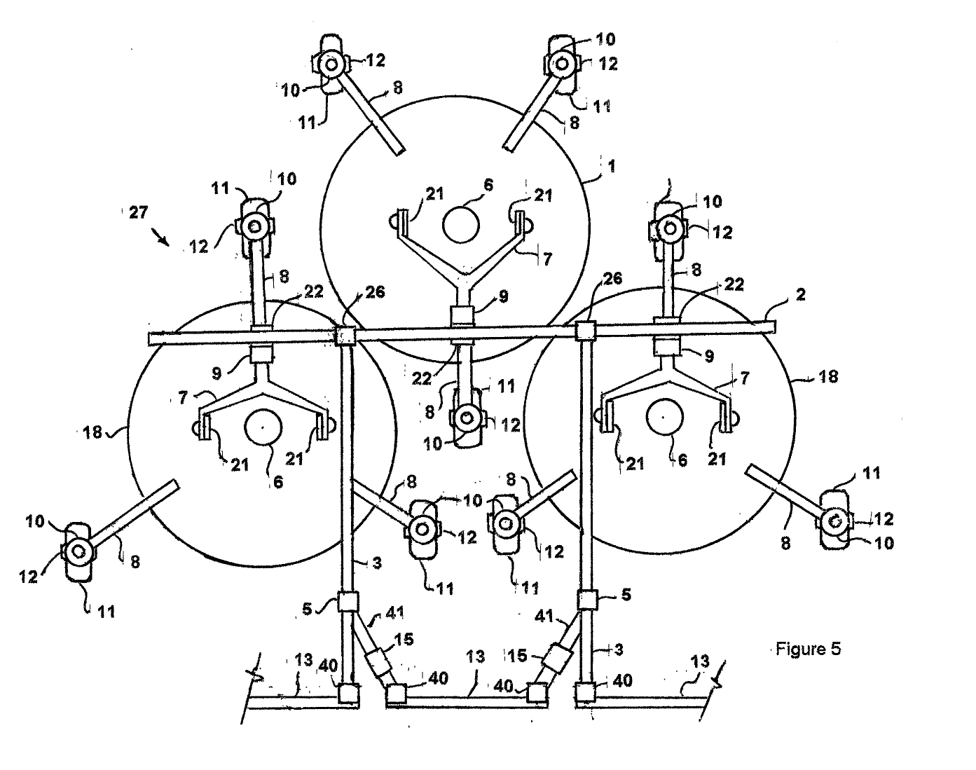

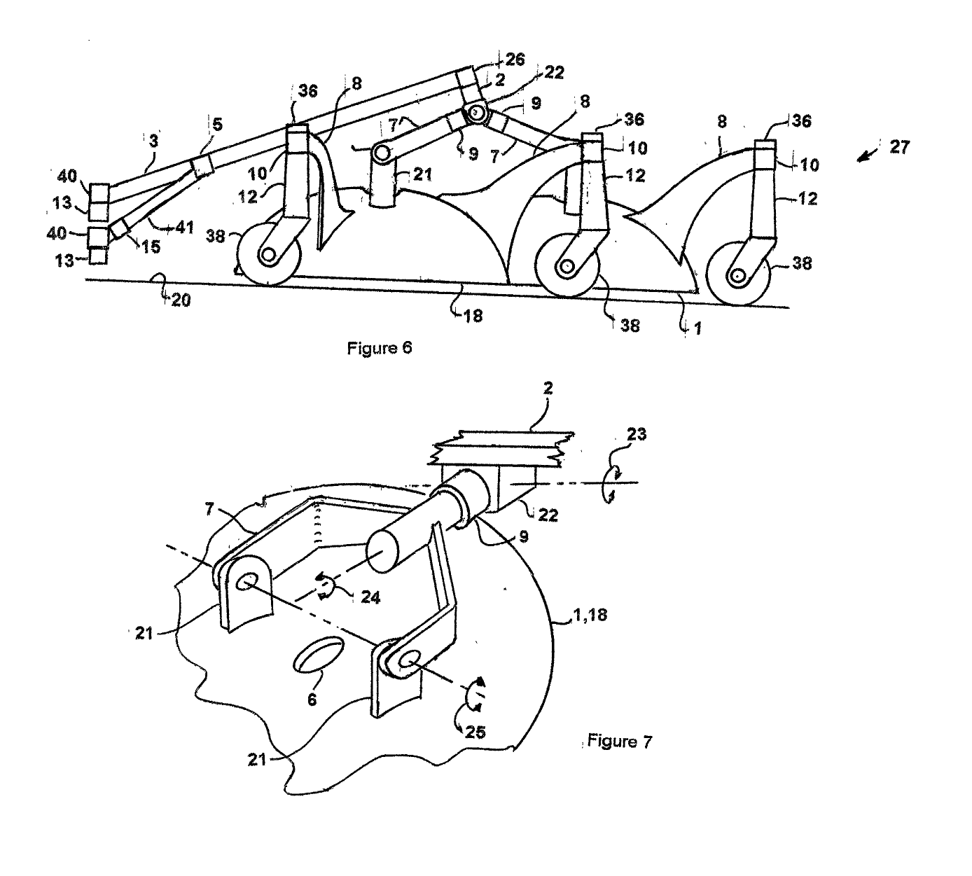

As shown in FIGS. 5 and 6. said assembly 27 is comprised of two cross bar supports 3, each flexibly affixed to the tractor frame 13 by hinged means, said hinged means comprising a base hinge 40 flexibly attached to said cross bar support 3, the distal ends of each of said cross bar support 3 being affixed to a cross bar 2, by two lift bar pivots 26 at points spaced at intervals along said cross bar's 2 length. FIG. 5 shows a top plan view of an assembly 27, FIG. 6 shows a side view of an assembly 27 and FIG. 7 shows the details of attachment of a housing 1, 18, to said cross bar 2. In the preferred embodiment of the present invention, each of said two cross bar supports 3 are supported by a lift bar 41 at a pivoting means, a center pivot 5 by said lift bar 41, said lift bar 41 being flexibly attached to said center pivot 5 and, at it's other end, to a lift actuator 28, said lift actuator 28 being attached to a hinged means, a base hinge 40, said base hinge 40 being affixed to said tractor frame 13. Said cross bar 2 is adjustably located away from said tractor and horizontally above the ground at a suitable distance from said tractor frame 13 by an extension means, a lift actuator 28. Rotational means comprised of three cross bar hinges 22 are affixed to said cross bar 2 and are attached tetween said lift bar supports 26 and the ends of said cross bar 2, said three cross bar hinges 22 are each attached to a yoke pivot 9 by axially rotation means, said axial rotation means comprising a yoke pivot 9 as shown in FIGS. 5, 6 and 7. In the preferred embodiment of the present invention, the support points, said lift bar pivots 26, are free to move upward allowing said cross bar 2 to rise slightly allowing said cross bar 2 to be tilted with respect to the ground.

Said cross bar hinges 22 are spaced along said cross bar 2 with the front housing 1 centered on said cross bar 2 and facing away from said cross bar 2 and said side housings 18 facing in the opposite direction as shown in FIGS. 5 and 6.

The yoke end of each of said housing yokes 7 is rotably attached to the top of said housings 1, 18 by two housing flanges 21 extending from and upward from the top of said housings, 1, 18. Each housing yoke 7 and the two housing flanges 21 are spaced apart by a distance sufficient to give clearance to a power means, a motor 32 as shown in FIG. 10, centered on the top of and affixed to each of said housings 1, 18 at the drive motor hole 6 on the top of each housing 1, 18 by a by attachment means, not shown, a drive shaft annular support 34, said drive shaft annular support 34 housing a drive shaft 33, said drive shaft 33 being affixed to transmit power to a horizontally rotating blade 35 from said motor 32 as shown in FIG. 10. Said motor 32 is in the preferred embodiment being a hydraulic motor. Said housings 1, 18 being adjustably supported by vertical wheel support adjustment means 36 as shown in FIG. 5, at a distance above the ground 20 by castered housing wheels 11, said mastering means being provided by pivoting wheel means 10 affixed to the end of a wheel support means 8, said wheel support means 8 affixed to the top of said housings and are attached tetween said lift bar supports 26 and the ends of said cross bar 2, said three cross bar hinges 22 are each attached to a yoke divot 9 by axially rotation means, said axial rotation means comprising a yoke pivot 9 as shown in FIGS. 5, 6 and 7. In the preferred embodiment of the present invention, the support points, said lift bar pivots 26, are free to move upward allowing said cross bar 2 to rise slightly allowing said cross bar 2 to be tilted with respect to the ground.

Said cross bar hinges 22 are spaced along said cross bar 2 with the front housing 1 centered on said cross bar 2 and facing away from said cross bar 2 and said side housings 18 facing in the opposite direction as shown in FIGS. 5 and 6.

The yoke end of each of said housing yokes 7 is rotably attached to the top of said housings 1, 18 by two housing flanges 21 extending from and upward from the top of said housings, 1, 18. Each housing yoke 7 and the two housing flanges 21 are spaced apart by a distance sufficient to give clearance to a power means, a motor 32 as shown in FIG. 10, centered on the top of and affixed to each of said housings 1, 18 at the drive motor hole 6 on the top of each housing 1, 18 by a by attachment means, not shown, a drive shaft annular support 34 said drive shaft annular support 34 housing a drive shaft 33, said drive shaft 33 being affixed to transmit power to a horizontally rotating blade 35 from said motor 32 as shown in FIG. 10. Said motor 32 is in the preferred embodiment being a hydraulic motor. Said housings 1, 18 being adjustably supported by vertical wheel support adjustment means 36 as shown in FIG. 5, at a distance above the ground 20 by castered housing wheels 11, said mastering means being provided by pivoting wheel means 10 affixed to the end of a wheel support means 8, said wheel support means 8 affixed to the top of said housings 1, 18 as shown in FIGS. 5 and 6. Said wheel pivoting means 10, a wheel yoke 12, is rotably affixed to a housing wheel 11. Said wheel support means 8 are affixed to each of said housings 1, 18 at intervals around the bottom edge of a 1, 18 providing three points of support off of the ground 20 for said castered wheels 11.

FIG. 6 shows a side view of a mower assembly 27 comprised of housings 1, 18, housing wheels 11 each rotably attached to a wheel yoke 12 which is rotably attached by pivot means, a wheel pivot 10, to a wheel support 8 which is affixed to a housing 1, 18. The elevation of said housings 1, 18, by adjustment means, being an adjustable distance above the ground 20, said adjustment means comprising wheel support adjustment means 36 shown schematically in FIG. 6.

FIG. 7 shows a perspective view of a typical housing 1, 18, said housing flanges 21 being affixed to the top of said housing 1, 18 rotably attached for rotation about an axis, a housing hinge axis 25, to said housing yoke 7, said housing yoke 7 being rotably attached with rotation about an axis, a pivot axis 24, to an annular means, said yoke pivot 9, said yoke pivot 9 being rotably attached to said cross bar hinge 22 about an axis, the cross bar axis 2, said cross bar hinge 22 being affixed to said cross bar 2. A motor hole 6 is shown in the top of said housing 1, 18 for affixing said motor 32.

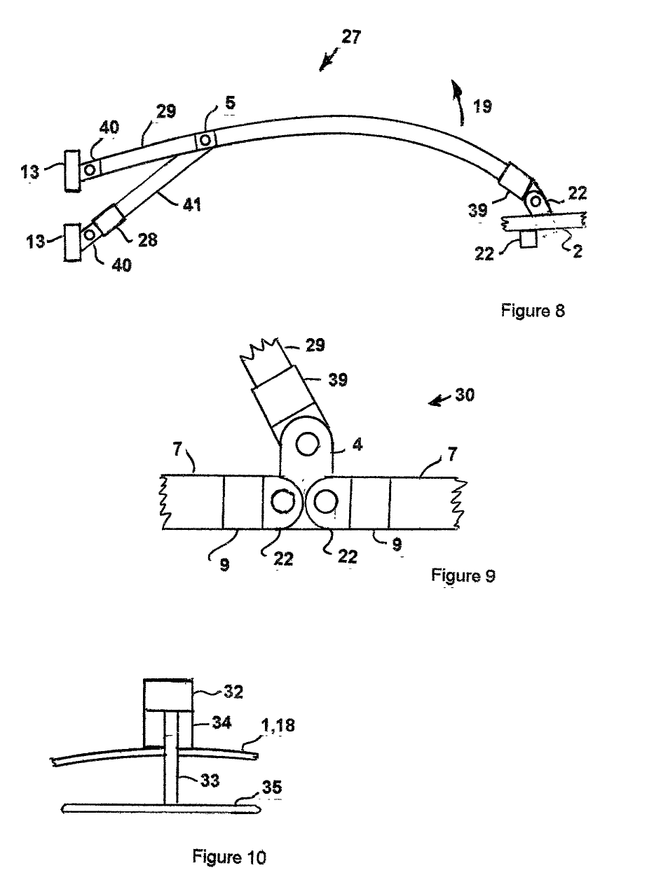

In another embodiment of the present invention, FIG. 8 shows a schematic side view of a side mounted mower assembly 27 having three housings 1, 18, not shown, with a lifting means, a swing arm 29, for elevating said mower assembly 27 above the ground 20. Said swing arm 29 is flexibly attached, by hinged means, a base hinge 40, affixing said swing arm 29 to the tractor frame 13 and at the distal end of said swing arm 29 to a securement means, an adjustment collar 39 which determines the orientation of said mower assembly 27, said adjustment collar 39 being attached by rotational means, said cross bar 22, which is affixed to a cross bar 2, as set out above. Said determination of the orientation of said cross bar 2 is with respect to the tractor frame 13.

The position of said swing arm 29 relative to the ground 20 is determined by a lift member 41 which is rotably attached to an extension means, a lift actuator 28, said lift actuator 28 being affixed to a base hinge 40 which is affixed to the tractor frame 13. Said lift actuator 28, by extension controls, not shown, extends the effective length of said lift member 41 raising said mower assembly 27 at a center pivot 5, said center pivot 5 being located along said swing arm's 29 length. The middle cross bar hinge 22 is connected to said cross bar 2 inboard of the the connection point, said cross bar hinge 22 connecting to said adjustment collar 39. The center of gravity of said cross bar 2 thus is tilted downward near the tractor 37 when said swing arm 29 is lifted by said lift actuator 28. The normal lifting motion to allow said housings 1, 18 to clear obstacles of the swing arm 29 is shown by a motion arrow 19.

In yet another embodiment of the present invention, FIG. 9 illustrates a side view of a swing arm 29 supporting two housings 1, 18. Said swing arm 29 is part of support assembly comprised of a hinged means, a base hinge 40, said base hinge 40 being attached to said tractor frame 13 and to said swing arm 29, the distal end of of said swing arm 29 connected to an axial adjustment means, an adjustment collar 39, said adjustment collar 39 being rotably connected to a hinged means, a T pivot 4, said T pivot being rotably connected to two cross bar hinges 22, each of said cross bar hinges 22 being connected to a housing yoke 7 as described above.

FIG. 10 shows a schematic side view of said motor 32 affixed to a drive shaft annular support 34, said annular support meand 34 surrounding a drive shaft 33 affixed at its lower end to a horizontal rotating blade 35, said drive shaft annular support 34 being affixed to said housing 1, 18.

The manner in which the mower assembly described above functions is to allow independent vertical motion of a housing by reason of the cross bar hinge 22, the yoke pivot 9, the housing yoke 7, the housing flanges 21 resulting in free vertical motion of the housings and free motion of the base of said housings 1, 18. The three independent axes of rotation, the cross bar hinge axis 23, the axial pivot axis 24 and the housing hinge axis 25 act with the freedom provided by said tiltable cross bar 2 to allow free orientation of a housing relative to other housings 1, 18. The yoke pivot 9 is a new degree of freedom which. with the assemblies described above, is the improved means which constitutes the present invention.

Thus it has been shown that an improved means for the creation of an improved mower assembly for cutting grass on uneven terrain can be made by mounting the housings independent of each other.

All of the above are only some of the examples of available embodiments of the present invention. Those skilled in the art will readily observe that numerous other modifications and alterations may be made without departing from the spirit and scope of the invention. Accordingly, the above disclosure is not intended as limiting and the appended claims are to be interpreted as encompassing the entire scope of the invention.

Reference Numerals - Description

| Numeral | Description |
|---|---|
| 1. | Front housing |
| 2. | Cross bar |
| 3. | Cross bar support |
| 4. | T pivot |
| 5. | Center pivot |
| 6. | Motor hole |
| 7. | Housing yoke |
| 8. | Wheel support |
| 9. | Yoke pivot |
| 10. | Wheel pivot |
| 11. | Housing wheel |
| 12. | Wheel yoke |
| 13. | Tractor frame |
| 14. | Frame hinge |
| 15. | Lift base pivot |
| 16. | Top bumper |
| 17. | Bumper guard |
| 18. | Side housing |
| 19. | Swing arm motion arrow |
| 20. | Ground |
| 21. | Housing flange |
| 22. | Cross bar hinge |
| 23. | Cross bar hinge axis |
| 24. | Axial pivot axis |
| 25. | Housing hinge axis |
| 26. | Lift bar pivot |
| 27. | General reference number for mower assembly |
| 28. | Lift actuator |
| 29. | Swing arm |
| 30. | General refernce number for lift joint |
| 31. | Motion arrow for tractor |
| 32. | Motor |
| 33. | Drive shaft |
| 34. | Drive shaft annular support |
| 35. | Blade |
| 36. | Wheel support adjustment means |
| 37. | General reference number for a tractor |
| 38. | Tractor wheel |
| 39. | Adjustment collar |
| 40. | Base hinge |
| 41. | Lift bar |

What is claimed is:

1. A rotary lawn mower, comprising a frame, wheel means connected to the frame to permit the frame to be moved over the ground, housing attachment means connecting said frame to at least two housings, wheel and/or roller means connected to each housing to permit each housing to be moved independently over the ground, power means mounted on said housing and including a drive shaft, rotable means disposed within the housing, said rotable means including an annular member journaled about said drive shaft, and a cutting blade carried by said annular member, said power means permitting the rotation of the drive shaft, said housing attachment means comprising,
at least one connecting member flexibly attached between said frame and,
a horizontal cross bar. said flexible attachment allowing said cross bar to be elevated with respect to the frame by,
tilting means and a tilting member for each at least one connection member and said tilting member flexibly attached to the frame and, at its other end, to a point along said at least one connecting member and said tilting means permitting the elevation of said tilting member, the connecting member and said cross bar and said flexible attachment allowing any connecting member to be elevated when said cross bar is tilted,
at least two lift bars, each with flexible connection means attached to said cross bar and to a housing and said flexible connection means comprised of,
an upper hinge connection between said cross bar and a lift bar and a lower hinge connection between said lift bar and a housing and axial rotation means provided by the hinge connections and/or said lift bar,
said cross bar position above the ground being adjustable vertically and normally positioned at a height to allow said housings to move freely up and down while its wheels and/or rollers are resting on the ground.

2. power means as in claim 1, comprised of a hydraulic motor,

3. at least one connecting member as in claim 1 comprised of two connecting members.

4. wheel and/or roller means as in claim 1 comprised of three wheels,

5. three wheels as in claim 4 comprised of castered wheels,

6. lift bars flexibly connected as in claim 1 comprised of lift bars connected to housings with said lift bars oriented alternately toward and away from said frame.

7. a lower hinge connection as in claim 1 comprised of a yoke attachment to a housing, said yoke hinged about opposite sides of said power means.

8. housings as in claim 1 attached to the front and/or rear of said frame.

9. housings as in claim 1 attached to the sides of the frame and/or under said frame.

10. power means, at least one connecting member, wheel and/or roller means as in claim 1, power means comprised of a hydraulic motor, at least one connecting member comprised of two connecting members, wheel and/or roller means comprised of three castered wheels, a lower hinge connection comprised of a yoke attachment to a housing, said yoke hinged about opposite sides of said power means, housings attached to the front and/or rear of said frame and/or housings attached to the sides of the frame and/or under said frame.

11. A rotary lawn mower, comprising a frame, wheel means connected to the frame to permit the frame to be moved over the ground, housing attachment means connecting said frame to at least two housings, wheel and/or roller means connected to each housing to permit each housing to be moved independently over the ground, power means mounted on said housing and including a drive shaft, rotable means disposed within the housing, said rotable means including an annular member journaled about said drive shaft, and a cutting blade carried by said annular member, said power means permitting the rotation of the drive shaft, said housing attachment means comprising,
a swing arm with flexible attachment means flexibly attached between said frame and rotational means for said swing arm,
a lift joint, said flexible attachment means allowing said lift joint to be elevated with respect to the frame by rotating said swing arm upward,
at least two lift bars, each with flexible connection means attached to said lift joint and to a housing and said flexible connection means comprised of,
an upper hinge connection between said lift joint and a lift bar and a lower hinge connection between said lift bar and a housing and axial rotation means provided by the hinge connections and/or said lift bar,
said lift joint being positioned vertically by adjustable means and/or by said swing arm and said lift joint being normally positioned above the ground at a height to allow said housings to move freely up and down while its wheels and/or rollers are resting on the ground

12. power means as in claim 11, comprised of a hydraulic motor,

13. at least one connecting member as in claim 11 comprised of two connecting members.

14. wheel and/or roller means as in claim 11 comprised of three wheels,

15. three wheels as in claim 14 comprised of castered wheels,

16. lift bars flexibly connected as in claim 11 comprised of two lift bars connected to housings with said lift bars oriented alternately to the front and to the rear of the frame from said lift joint.

17. a lower hinge connection as in claim 11 comprised of a yoke attachment to a housing, said yoke hinged about opposite sides of said power means.

18. housings as in claim 11 attached to the front and/or rear of said frame.

19. housings as in claim 11 attached to the sides of the frame and/or under said frame.

20. power means, at least one connecting member, wheel and/or roller means as in claim 11, power means comprised of a hydraulic motor, at least one connecting member comprised of two connecting members, wheel and/or roller means comprised of three castered wheels, a lower hinge connection comprised of a yoke attachment to a housing, said yoke hinged about opposite sides of said power means, housings attached to the front and/or rear of said frame and/or housings attached to the sides of the frame and/or under said frame.

21. A rotary lawn mower, comprising a frame, wheel means connected to the frame to permit the frame to be moved over the ground. housing attachment means connecting said frame to at least two housings, wheel and/or roller means connected to each housing to permit each housing to be moved independently over the ground, power means mounted on said housing and including a drive shaft, rotable means disposed within the housing, said rotable means including an annular member journaled about said drive shaft, and a cutting blade carried by said annular member, said power means permitting the rotation of the drive shaft, said housing attachment means comprising,
at least one connecting member flexibly attached between said frame and,
a horizontal cross bar, said flexible attachment allowing said cross bar to be elevated with respect to the frame by,
tilting means and a tilting member for each at least one connection member and said tilting member flexibly attached to the frame and, at its other end, to a point along said at least one connecting member and said tilting means permitting the elevation of said tilting member, the connecting member and said cross bar and said flexible attachment allowing any connecting member to be elevated when said cross bar is tilted,
at least two lift bars, each with flexible connection means attached to said cross bar and to a housing with compact nesting of said housings and bumper means for one of two adjacent housings, and said flexible connection means comprised of,
an upper hinge connection between said cross bar and a lift bar and a lower hinge connection between said lift bar and a housing and axial rotation means provided by the hinge connections and/or said lift bar,
said cross bar position above the ground being adjustable vertically and normally positioned at a height to allow said housings to move freely up and down while its wheels and/or rollers are resting on the ground.

22. at least one connecting member as in claim 21 comprised of two connecting members.

23. wheel and/or roller means as in claim 21 comprised of three castered wheels,

24. lift bars flexibly connected as in claim 21 comprised of lift bars connected to housings with said lift bars oriented alternately toward and away from said frame.

25. wheel and/or roller means, compact nesting, bumper means and lift bars flexibly connected as in claim 21 comprised of three castered wheels equally spaced around the periphery of each housing, and lift bars connected to housings with said lift bars oriented alternately toward and away from the front or rear of said frame and all housings having a single castered wheel oriented toward or away from the cross bar with adjacent housing spaced closely and having bumper means on one of said adjacent housings to arrest and lockup the other housing when the group is lifted.

26. a lower hinge connection as in claim 21 comprised of a yoke attachment to a housing, said yoke hinged about opposite sides of said power means.

27. housings as in claim 21 attached to the front and/or rear of said frame.

28. housings as in claim 21 attached to the sides of the frame and/or under said frame.

29. power means, at least one connecting member, wheel and/or roller means as in claim 21, power means comprised of a hydraulic motor, at least one connecting member comprised of two connecting members, wheel and/or roller means comprised of three castered wheels, a lower hinge connection comprised of a yoke attachment to a housing, said yoke hinged about opposite sides of said power means, housings attached to the front and/or rear of said frame and/or housings attached to the sides of the frame and/or under said frame.

30. A rotary lawn mower, comprising a frame, wheel means connected to the frame to permit the frame to De moved over the ground, housing attachment means connecting said frame to at least two housings, wheel and/or roller means connected to each housing to permit each housing to be moved independently over the ground, power means mounted on said housing and including a drive shaft, rotable means disposed within the housing, said rotable means including an annular member journaled about said drive shaft, and a cutting blade carried by said annular member, said power means permitting the rotation of the drive shaft, said housing attachment means comprising,
a swing arm with flexible attachment means flexibly attached between said frame and rotational means for said swing arm,
a lift joint, said flexible attachment means allowing said lift joint to be elevated with respect to the frame by rotating said swing arm upward,
at least two lift bars, each with flexible connection means attached to said lift joint and to a housing with compact nesting of said housings and bumper means for one of two adjacent housings, and said flexible connection means comprised of,
an upper hinge connection between said lift joint and a lift bar and a lower hinge connection between said lift bar and a housing and axial rotation means provided by the hinge connections and/or said lift bar,
said lift joint being positioned vertically by adjustable means and/or by said swing arm and said lift joint being normally positioned above the ground at a height to allow said housings to move freely up and down while its wheels and/or rollers are resting on the ground.

31. at least one connecting member as in claim 30 comprised of two connecting members.

32. wheel and/or roller means as in claim 30 comprised of three castered wheels.

33. wheel and/or roller means, compact nesting, bumper means and lift bars flexibly connected as in claim 30 comprised of three castered wheels equally spaced around the periphery of each housing, and lift bars connected to housings with said lift bars oriented alternately toward and away from the front or rear of said frame and all housings having a single castered wheel oriented toward or away from the cross bar with adjacent housing spaced closely and having bumper means on one of said adjacent housings to arrest and lockup the other housing when the group is lifted.

34. lift bars flexibly connected as in claim 30 comprised of two lift bars connected to housings with said lift bars oriented alternately to the front and to the rear of the frame from said lift joint.

35. a lower hinge connection as in claim 30 comprised of a yoke attachment to a housing, said yoke hinged about opposite sides of said power means.

36. housings as in claim 30 attached to the front and/or rear of said frame.

37. housings as in claim 30 attached to the sides of the frame and/or under said frame.

38. power means, at least one connecting member, wheel and/or roller means as in claim 30, power means comprised of a hydraulic motor, at least one connecting member comprised of two connecting members, wheel and/or roller means comprised of three castered wheels, a lower hinge connection comprised of a yoke attachment to a housing, said yoke hinged about opposite sides of said power means, housings attached to the front and/or rear of said frame and/or housings attached to the sides of the frame and/or under said frame.
